(19) United States
(12) Patent Application Publication
(10) Pub. No.: US 2025/0253529 A1
(43) Pub. Date: Aug. 7, 2025

(54) MULTI-PORT ANTENNA FOR DIRECTION FINDING AND METHOD OF MANUFACTURING THE SAME

(71) Applicants: HONG UNIVERSITY INDUSTRY-ACADEMIA CORPORATION FOUNDATION, Seoul (KR); KOOKMIN UNIVERSITY INDUSRTY ACADEMY COOPERATION FOUNDATION, Seoul (KR)

(72) Inventors: Hyunmu KANG, Seoul (KR); Jongho Keun, Seoul (KR); Sangwoon Youn, Seoul (KR); Byung-Jun Jang, Seoul (KR); Hosung Choo, Seoul (KR)

(21) Appl. No.: 19/047,186

(22) Filed: Feb. 6, 2025

(30) Foreign Application Priority Data
Feb. 4, 2024 (KR) 10-2024-0019180
Sep. 12, 2024 (KR) 10-2024-0125106

(51) Int. Cl. H01Q 5/307; H01Q 1/38; H01Q 21/00

(52) U.S. Cl. CPC H01Q 5/307; H01Q 1/38; H01Q 21/0037

(57) ABSTRACT

A single radiator multi-port antenna includes a substrate, a radiator formed on the substrate, three or more ports connected to the radiator and configured to function as feed points for supplying a current to the radiator, and a plurality of vias formed on the substrate or at least one of the ports, wherein the plurality of vias includes at least one of a first via formed at a certain interval from the radiator and a second via formed in the three or more ports.

### CROSS-REFERENCE TO RELATED APPLICATION

This application is based on and claims priority under 35 U.S.C. § 119 to Korean Patent Application No. 10-2024-0019180, filed on Feb. 7, 2024, and 10-2024-0125106, filed on Sep. 12, 2024, in the Korean Intellectual Property Office, the disclosures of which are incorporated by reference herein in their entirety.

### BACKGROUND

### 1. Field

The disclosure relates to a structure of a multi-port antenna for direction finding and a method of manufacturing the same.

### 2. Description of the Related Art

Ultra-Wide Band (UWB) technology is a wireless technology that uses narrow pulses in the time domain and has a much wider bandwidth than existing wireless communication technologies in the frequency domain. According to the definition of the US Federal Communications Commission (FCC), UWB technology uses a frequency bandwidth of 500 MHz or more.

UWB technology may be used to establish short-range wireless personal networks and has been widely used in services using positioning due to the characteristics for measuring a distance between devices as well as wireless communication between devices.

However, to provide a location-based service using HRP UWB technology, it is necessary to detect not only a distance between UWB devices (e.g., UWB anchor and UWB tags) but also a direction thereof.

### SUMMARY

A single radiator multi-port antenna according to an embodiment includes a substrate, a radiator formed on the substrate, three or more ports connected to the radiator and configured to function as feed points for supplying current to the radiator, and a plurality of vias formed on the substrate or at least one of the ports, wherein the plurality of vias includes at least one of a first via formed at a certain interval from the radiator and a second via formed on the ports.

A method of manufacturing a single radiator multi-port antenna, according to an embodiment includes forming a substrate including a dielectric material, forming three or more ports that function as feed points for supplying current to the radiator, and forming a plurality of vias on the substrate or at least one of the ports, wherein the plurality of vias include at least one of a first via formed at a certain interval from the radiator and a second via formed on the ports.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a system environment for performing Ultra-Wide Band (UWB)-based direction measurement, according to an embodiment;

FIG. 2 is a diagram illustrating an antenna according to an embodiment;

FIG. 3 is an exploded perspective view of an antenna according to an embodiment;

FIG. 4 is an exploded perspective view of an antenna according to an embodiment;

FIG. 5 shows a table and graph illustrating wideband characteristics of an antenna according to an embodiment;

FIGS. 6A to 6C shows graphs obtained by measuring a bandwidth and gain of an antenna according to an embodiment;

FIG. 7 is a diagram illustrating a structure of an antenna including a slot formed in a radiator, according to an embodiment;

FIG. 8 is a diagram illustrating a method of finding a direction by using an antenna, according to an embodiment; and

FIG. 9 is a flowchart illustrating a method of manufacturing an antenna according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

With regard to the description of the disclosure, technical features that are not directly associated with the disclosure are not described here. Certain detailed explanations of related art are omitted for clarity when it is deemed that they may unnecessarily obscure the essence of the disclosure. The terms used in the specification are defined in consideration of functions used in the disclosure, and may be changed according to the intent or conventionally used methods of clients, operators, and users. Accordingly, definitions of the terms should be understood on the basis of the entire description of the present specification.

In the same reason, some components in the following drawings may be exaggerated, omitted, or schematically illustrated. The sizes of components do not reflect their actual sizes completely. The same reference number is given to the same or corresponding components in each drawing.

Advantages and features of the disclosure, and methods of achieving them may be clear with reference to the detailed description of the following embodiments taken in conjunction with the accompanying drawings. However, the disclosure is not limited to the embodiments disclosed below, but may be implemented in various different forms. These embodiments are intended to complete the disclosure, and are common in the art to which the disclosure belongs, and it is provided to fully inform the person skilled in the art of the scope of the disclosure. An embodiment is defined by the scope of the claims. Like reference numerals refer to like elements throughout the specification. In the following description of the disclosure, a detailed description of functions and configurations incorporated herein will be omitted when it may make the subject matter of the disclosure unclear. The following terms used in the specification are defined in consideration of functions used in the disclosure, and may be changed according to the intent or conventionally used methods of operators and users. Accordingly, definitions of the terms need to be understood on the basis of the entire description of the specification.

According to an embodiment, combinations of each block of flowcharts and the flowcharts may be performed by computer program instructions. Computer program instructions may be installed on a processor of a general computer, a special computer or other programable data processing equipment, and the instructions executed through the processor of the computer or other programable data processing equipment may generate an element for performing functions described in block(s) of flowcharts. Computer program instructions may be stored in computer available or computer readable memory that may aim for a computer or other data processing equipment to implement functions in a certain way, and instructions stored in the computer available or computer readable memory may also produce manufacturing items that contain instruction elements for performing the functions described in the block(s) of the flowcharts. It is also possible that computer program instructions are installed on a computer or other programable data processing equipment.

Each block of flowcharts may indicate a part of a module, segment or code including one or more executable instruments for executing a certain logical function(s). According to an embodiment, it is also possible that functions mentioned in the blocks are performed out of order. For example, two blocks that are consecutively shown may actually be performed at the same time, or in reverse order depending on the function.

The term “unit” in an embodiment means a software component or a hardware component, such as a Field Programmable Gate Array (FPGA) or an Application Specific Integrated Circuit (ASIC), that performs a certain function. However, the term “unit” is not limited to software or hardware. The “unit” may be formed to be stored in an addressable storage medium, or may be formed to operate one or more processors. In an embodiment, the term “unit” may refer to components such as software components, object-oriented software components, class components, and task components, processes, functions, attributes, procedures, subroutines, segments of program code, drivers, firmware, micro code, circuits, data, databases, data structures, tables, arrays, and parameters. Functions provided by certain elements and a certain “unit” may be combined in a smaller number of elements or may be separated into additional elements. In an embodiment, the “unit” may include one or more processors.

Prior to describing certain embodiments, the terms frequently used in the disclosure will be described.

In the disclosure, “direction finding” or “direction measurement” refers to an operation of determining the direction of a terminal transmitting a signal, based on the direction of the signal (i.e., a radio wave). For example, a relative direction between terminals performing Ultra-Wide Band (UWB) communication may be found, and a UWB terminal receiving a signal may find the direction (a direction based on the UWB terminal receiving the signal) of a UWB terminal transmitting the signal by measuring the angle of arrival of the signal.

A “Single Radiator Multi-Port (SRMP) antenna” may refer to an antenna that may transmit and receive signals through multiple ports while using a single radiator. According to an embodiment, the SRMP antenna may include a single patch-shaped radiator, and the radiator may have a plurality of ports formed to function as feed points. The SRMP antenna may form a plurality of beam patterns that are different from each other depending on a port to which current is supplied. The antennas of embodiments introduced in the disclosure are in the form of SRMP antennas.

Hereinafter, specific embodiments will be described with reference to the drawings.

### 1. Proposal of an Antenna Structure Used for Direction Finding Using UWB Communication

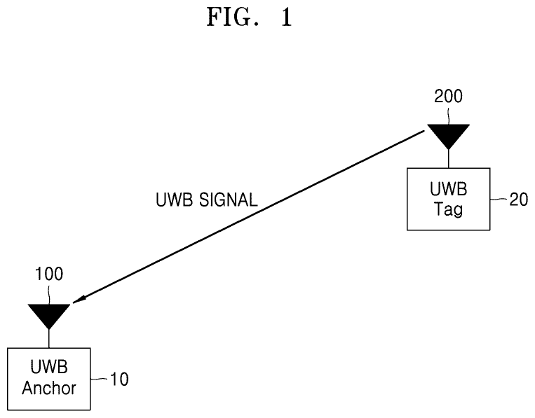

FIG. 1 is a diagram illustrating a system environment for performing UWB-based direction measurement, according to an embodiment. Referring to FIG. 1, a system may include two UWB devices, that is, a UWB anchor 10 and a UWB tag 20. According to an embodiment, the system may be configured to include a plurality of UWB anchors 10 and UWB tags 20. The UWB anchor 10 and the UWB tag 20 may transmit and receive signals (radio waves) through antennas 100 and 200, respectively.

The UWB tag 20 may provide location information to the UWB anchor 10. That is, when the UWB tag 20 transmits a signal (radio wave) to the UWB anchor 10, the UWB anchor 10 may determine a location (a distance and a direction) of the UWB tag 20 based on a received signal.

According to an embodiment, the UWB anchor 10 may measure the distance to the UWB tag 20 by using a Two-Way Ranging (TWR) method using Time of Flight (ToF), which is the time for a signal to be transmitted and received between two devices. In addition, the distance between the UWB anchor 10 and the UWB tag 20 may be measured using various methods. Because the TWR method is a known technology and the disclosure relates to an antenna for direction finding between UWB devices, that is, the UWB anchor 10 and the UWB tag 20, a detailed description of the distance measurement method is omitted.

Existing UWB-based direction finding is performed by a Phase Difference of Arrival (PDoA) method using a plurality of antennas spaced apart from each other by half the wavelength of the transmitted and received radio waves. The PDoA method is a technology that measures the angle of incidence of a signal by using the difference in an arrival path of a signal (radio wave) received through different antennas and a resulting phase difference of the signal. However, the PDoA method has the following limitations.
1) Because a plurality of antennas have to be installed spaced apart from each other by half the wavelength, a lot of antenna installation space is required and antenna placement is difficult.
2) Antenna design is difficult because errors may occur due to influences such as grounding plates and mutual coupling.
3) Because it is sensitive to phase error, calibration work is required to reduce phase errors due to a feed line from the antennas to a receiver and phase errors of the receiver.
4) Because direction finding is possible only by using the phase difference of a direct wave (Line of Sight (LOS)), the error increases when a reflected wave (Non-Line of Sight (NLoS)) is also incident.

In the disclosure, a structure of an antenna that may be miniaturized while resolving the limitations of the PDoA method described above is presented. A plurality of antennas are required for direction finding, but in the disclosure, a structure of an antenna that may perform direction finding with a single antenna is presented for miniaturization of an antenna module. In other words, in the disclosure, an antenna structure, in which radiators of a plurality of antennas are integrated into a single radiator and a plurality of ports (feed points) are formed in the single radiator, is presented.

In addition, according to an embodiment, an antenna structure is presented to resolve problems that may occur due to miniaturization of the antenna, such as low gain characteristics and increased interference between ports (feed points). This will be described in more detail with reference to FIG. 1 as follows.

The antenna 100 included in the UWB anchor 10 according to an embodiment has a structure in which three or more ports (feed points) are formed in one radiator, and thus, direction finding may be performed using one antenna 100. Therefore, the antenna 100 according to an embodiment may solve the problems of the PDoA method using a plurality of antennas, described above.

However, when three or more ports are formed in one radiator, interference between the ports may be severe, and also, when the antenna 100 is miniaturized and the size of the radiator decreases, problems such as a decrease in the gain of the antenna 100 may occur.

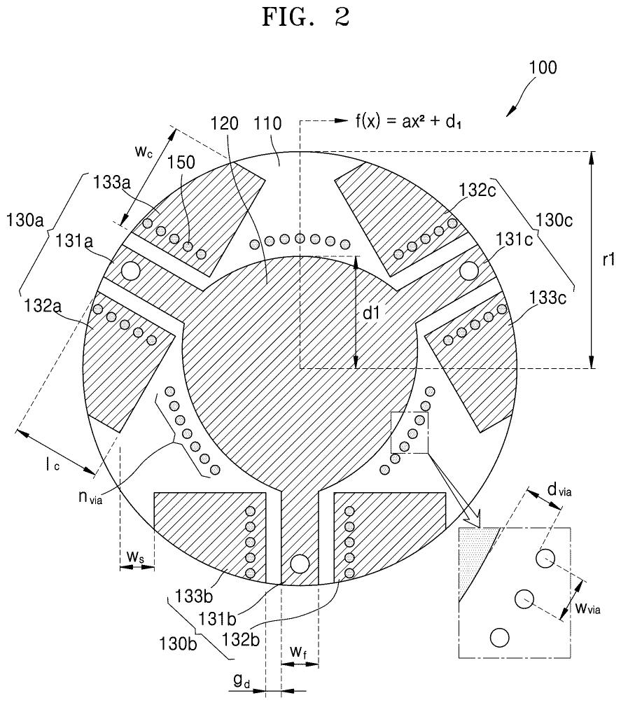

The antenna 100 according to an embodiment may solve the above problems by making the port have a CPW structure and forming vias at appropriate locations on the antenna 100. The structure of the antenna 100 according to embodiments will be described in detail with reference to FIGS. 2 to 4 below.

The antenna 100 that is an SRMP antenna having a new structure according to embodiments may be used not only for direction finding using UWB communication, but also for performing communication using various other communication protocols.

### 2. Structure of SRMP Antenna According to Embodiments

FIG. 2 is a diagram illustrating an antenna according to an embodiment. Hereinafter, the structure of the antenna according to an embodiment will be described in detail with reference to FIG. 2.

The antenna 100 according to an embodiment may be a patch antenna including a radiator 120 in the form of a patch. As illustrated in FIG. 2, the antenna 100 may include one radiator 120, and the radiator 120 may have a circular or nearly circular shape.

The antenna 100 according to an embodiment may have a dielectric laminated structure. For example, the radiator 120 may be made by forming a thin metal plate through etching on a substrate 110 including a dielectric material. The antenna 100 according to an embodiment may derive wideband characteristics by applying a quadratic function f(x)=ax²+d₁ (a is any real number) as a curvature to a radiator 120 having a radius (the shortest distance from the border of the radiator 120 to the center of the radiator 120 when the radiator 120 is not a circle) of d1. In other words, the curvature of the border of the radiator 120 according to an embodiment may be expressed as a quadratic function determined by the shortest distance from the border of the radiator 120 to the center of the radiator 120.

According to an embodiment, the substrate 110 may be manufactured with Flame Retardant (FR)-4 material and have a thickness of about 1.6 mm, and the overall size of the antenna 100 may be manufactured to be less than half a wavelength. The antenna 100 may be manufactured with various materials and specifications.

The antenna 100 according to an embodiment may be an SRMP type antenna in which a plurality of ports are connected to one radiator 120. Referring to FIG. 2, a plurality of ports 130a, 130b, and 130c that function as feed points may be formed in the radiator 120.

According to an embodiment, the plurality of ports 130a, 130b, and 130c may be formed to be connected to the border of the radiator 120. In other words, the plurality of ports 130a, 130b, and 130c may be formed on the perimeter of the radiator 120. In addition, according to an embodiment, the plurality of ports 130a, 130b, and 130c may be arranged at regular intervals with rotational symmetry based on the center of the radiator 120. Referring to FIG. 2, three ports 130a, 130b, and 130c are arranged at 120-degree intervals in the antenna 100. According to an embodiment, four or more ports may be formed in the radiator 120 of the antenna 100.

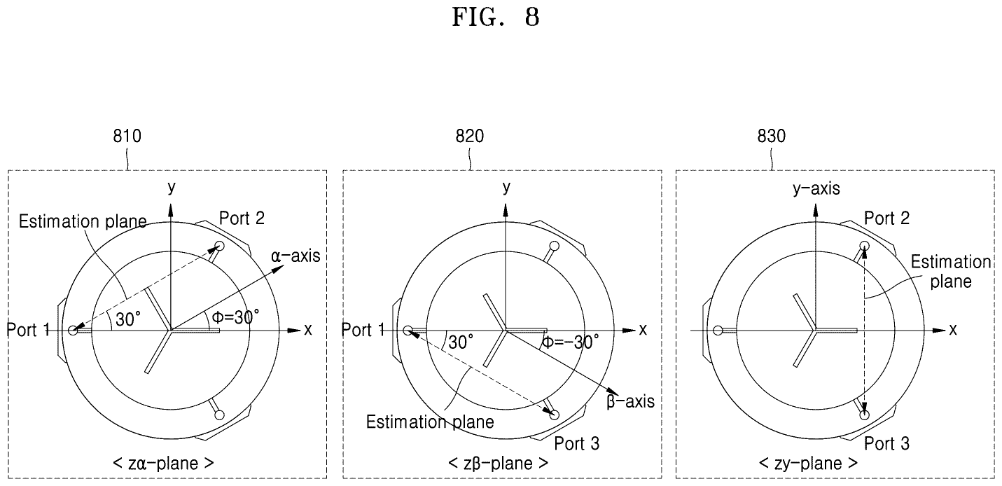

According to an embodiment, because three ports 130a, 130b, and 130c are connected to the radiator 120 of the antenna 100 with rotational symmetry, up, down, left, and right direction finding may be performed with only one antenna 100 without an additional antenna. Therefore, there is an advantage in that an antenna module included in a terminal (e.g. the UWB anchor 10) may be miniaturized. For example, the UWB anchor 10 of FIG. 1 may find the direction of the UWB tag 20 in a monopulse direction finding manner based on three estimation planes determined based on the three ports 130a, 130b, and 130c. This will be described in detail with reference to FIG. 8 below.

In addition, the antenna 100 according to an embodiment may operate over a wide bandwidth by including the plurality of ports 130a, 130b, and 130c for feed, and the antenna 100 may be made to output various beam patterns by appropriately distributing signals to each of the ports 130a, 130b, and 130c.

According to an embodiment, the antenna 100 may include a first port 130a, a second port 130b, and a third port 130c, and each of the ports 130a, 130b, an 130c may be a feed section of a Coplanar Waveguide (CPW) structure.

The first port 130a may include a center strip 131a and CPW grounds 132a and 133a located at a certain interval on both sides of the center strip 131a. According to an embodiment, components 131a, 132a, and 133a included in the first port 130a may also be made by forming a thin metal plate on the substrate 110 through etching.

For the operation of the antenna 100, a current (signal) may be transmitted through the central strip 131a. The CPW grounds 132a and 133a on both sides of the center strip 131a may be located on the same plane as the central strip 131a to provide a return path for the current.

According to an embodiment, a plurality of vias 150 may be formed on the CPW grounds 132a and 133a. The plurality of vias 150 formed on the CPW grounds 132a and 133a may be arranged in a direction parallel to the central strip 131a. An isolation effect of the first port 130a may be increased due to the vias 150 formed on the CPW grounds 132a and 133a. Specifically, the vias 150 formed on the CPW grounds 132a and 133a may block an electromagnetic field passing from the central strip 131a to the outside, and thus, a feed efficiency may be increased. In addition, an electromagnetic field passing from the first port 130a to other ports 130b and 130c may also be blocked by the vias 150, and thus, the effect of preventing interference between ports may also be expected.

The structure including the central strip 131a and the CPW grounds 132a and 133a is referred to as a Coplanar Waveguide with Ground (CPWG) structure, and this structure is advantageous for stable feed, and thus, the feed efficiency may be increased. A fed signal may be transmitted to other ports along the edge of a central radiator, which may have a negative effect on mutual interference characteristics. However, CPW grounds 132b, 133b, 132c, and 133c of adjacent ports 130b and 130c other than the first port 130a used for feed may excite current and block current transmitted to the other ports 130b and 130c to thereby exhibit low mutual coupling characteristics. Therefore, the structure illustrated in FIG. 2 may be defined as a self-decoupling feed structure (SDFS).

The second port 130b and the third port 130c may have the same structure as the first port 130a. The second port 130b may include a central strip 131b and CPW grounds 132b and 133b located at a certain interval on both sides of the central strip 131b. In addition, the third port 130c may include a central strip 131c and CPW grounds 132c and 133c located at a certain interval on both sides of the central strip 131c.

Similar to the first port 130a, a plurality of vias 150 may be formed in the CPW grounds 132b and 133b of the second port 130b and the CPW grounds 132c and 133c of the third port 130c. Therefore, the second port 130b and the third port 130c may also expect the same effects as the effects (improved feed efficiency, strengthened isolation, interference prevention, etc.) generated by forming the vias 150 in the CPW grounds 132a and 133a of the first port 130a described above.

As described above, the ports 130a, 130b, and 130c included in the antenna 100 according to an embodiment have a plurality of vias 150 formed on the CPW grounds 132a, 133a, 132b, 133b, 132c, and 133c to have a self-decoupling feed structure (SDFS), thereby improving feed efficiency and reducing interference between the ports 130a, 130b, and 130c.

The antenna 100 according to an embodiment may include a plurality of vias 140 formed on the substrate 110 around the radiator 120. Referring to FIG. 2, the plurality of vias 140 may be arranged around the radiator 120 along the border of the radiator 120 at a constant interval from the radiator 120. The effects that occur by forming the plurality of vias 140 around the radiator 120 are as follows:

### 1) Increased Gain of Antenna

The antenna 100 according to an embodiment may increase the gain of the antenna 100 by concentrating a leaked electromagnetic field around the radiator 120 by arranging the plurality of vias 140 around the radiator 120. When a patch antenna is made small, the antenna gain is reduced due to a small radiator, which hinders the miniaturization of the antenna. However, the antenna 100 according to an embodiment can remedy the low gain characteristic due to the small radiator through the plurality of vias 140 formed around the radiator 120, and thus, the antenna 100 may be miniaturized by making the radiator 120 small.

### 2) Prevention of Interference Between Ports

When the plurality of vias 140 are arranged around the radiator 120 as in the antenna 100 according to an embodiment, the electromagnetic field between the radiator 120 and the vias 140 is strengthened, and thus, the current passing through the radiator 120 between the ports 130a, 130b, and 130c decreases. As a result, the coupling between the ports 130a, 130b, and 130c may be weakened, and thus, the interference effect may be weakened.

That is, the coupling between the ports 130a, 130b, and 130c may be strengthened due to the current passing from one port to another port through the outer line of the radiator 120. However, in the antenna 100 according to an embodiment, the coupling may be effectively reduced by installing the vias 140 in a direction in which the current flows on the outside of the radiator 120.

In other words, by concentrating the electromagnetic field and current to the radiator 120 through the vias 140 around the radiator 120, the amount of current transferred from one port to another port may be suppressed, and thus, the interference effect between the ports 130a, 130b, and 130c may be weakened.

The antenna 100 according to an embodiment may increase the isolation effect between the ports 130a, 130b, and 130c by forming the ports 130a, 130b, and 130c in a CPW structure, thereby enabling miniaturization of the antenna 100. To explain in a little more detail, as the CPW grounds 132a, 133a, 132b, 133b, 132c, and 133c and the radiator 120 are coupled together, a portion of the electromagnetic field that resonate along the outer line of the radiator 120 between two adjacent ports is transferred to the CPW grounds 132a, 133a, 132b, 133b, 132c, and 133c and causes resonance, and thus, the electromagnetic field passing to other ports may be reduced. Therefore, the degree of coupling of the ports 130a, 130b, and 130c may be reduced, and thus, interference characteristics may be reduced.

In the antenna 100 according to an embodiment, the ports 130a, 130b, and 130c are formed on the border of the radiator 120, thereby directly feeding the radiator 120. In this way, in a structure of directly feeding the radiator 120, a problem of high interference characteristics may occur. However, the antenna 100 according to an embodiment may solve the above problem by forming the ports 130a, 130b, and 130c in a CPW structure and forming the vias 140 and 150 around the radiator 120 and on the CPW grounds 132a, 133a, 132b, 133b, 132c, and 133c to lower the interference characteristics.

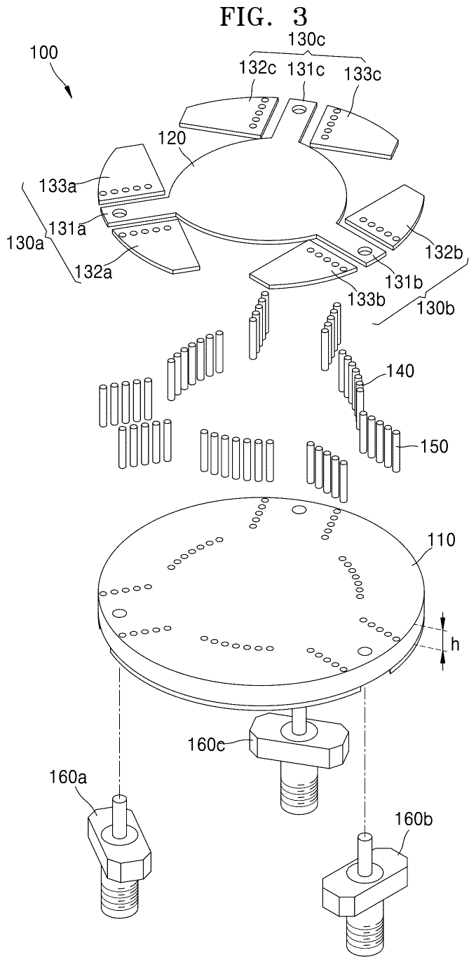

FIG. 3 is an exploded perspective view of an antenna 100 according to an embodiment. FIG. 3 is a diagram to help understand the structure of the antenna 100 in three dimensions, and the structure of the antenna 100 illustrated in FIG. 3 is the same as the structure of the antenna 100 illustrated in FIG. 2. Because the components included in the antenna 100, effects due to the components, and the like have already been described in detail with reference to FIG. 2, the same description will be omitted, and only the three-dimensional structure of the antenna 100 that may be confirmed in FIG. 3 will be briefly described.

Referring to FIG. 3, vias 140 and 150 may be assembled in a manner that the vias 140 and 150 are inserted into grooves formed on a substrate 110 of the antenna 100. Holes for the vias 150 to pass through may be formed in CPW grounds 132a, 133a, 132b, 133b, 132c, and 133c.

In FIG. 2, the antenna 100 is not visible because the antenna 100 is viewed from above, but referring to FIG. 3, connectors 160a, 160b, and 160c may be connected to positions corresponding to ports 130a, 130b, and 130c on the bottom surface of the substrate 110 of the antenna 100. Current may be supplied to the ports 130a, 130b, and 130c through the connectors 160a, 160b, and 160c.

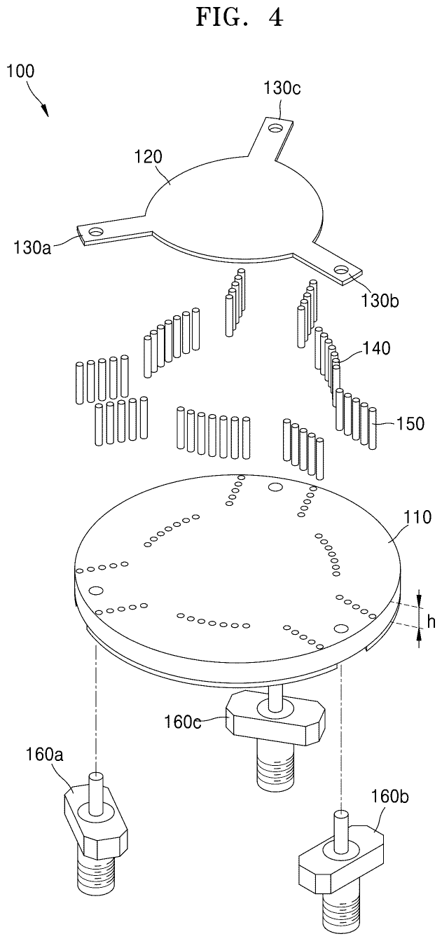

FIG. 4 is an exploded perspective view of an antenna 100 according to an embodiment. The antenna 100 illustrated in FIG. 4 has ports 130a, 130b, and 130c formed not as a CPW structure but as a microstrip line-shaped feed line. Other structures are the same as the antenna 100 illustrated in FIGS. 2 and 3, and detailed descriptions of the structures are omitted.

Because the ports 130a, 130b, and 130c of the antenna 100 shown in FIG. 4 are not formed as a CPW structure, the effects due to the CPW structure described above may not be expected. However, as vias 140 and 150 are formed around a radiator 120 and the feed lines of the ports 130a, 130b, and 130c, the effects of increasing gain and decreasing interference characteristics may be expected.

### 3. Operating Characteristics (Experimental Results) of an SRMP Antenna According to Embodiments

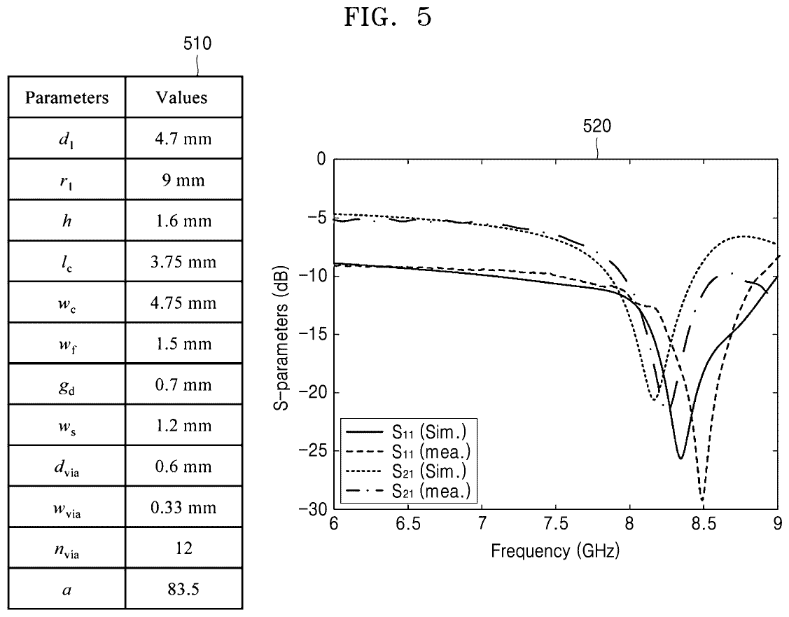

FIG. 5 is a table and graph illustrating the wideband characteristics of an antenna according to an embodiment. The first table 510 of FIG. 5 describes numerical values of each part of the antenna 100 of FIG. 2. The first graph 520 of FIG. 5 shows the results of measuring the S-parameter (Scattering-parameter) of the antenna 100 manufactured according to the numerical values described in the first table 510. S₁₁ is a reflection coefficient and indicates the rate at which a signal input to one port is reflected back to the port. S₂₁ is a transmission coefficient and indicates the rate at which a signal input to one port is transmitted to another port. The first graph 520 shows simulation results Sim. and actual measurement values mea. for each of S₁₁ and S₂₁.

As described above with reference to FIG. 2, the antenna 100 according to an embodiment may have a wideband characteristic by setting the curvature of the radiator 120 according to a quadratic function f(x)=ax²+d₁. Referring to the first graph 520, it may be confirmed that the antenna 100 of FIG. 2 manufactured according to the numerical values described in the first table 510 has a bandwidth of about 2.1 GHz with a −10 dB operating frequency of about 6.3 GHz to about 8.4 GHz. This is a value that satisfies the bandwidth (about 7.737 GHz to about 8.236 GHZ) of UWB Channel 9 currently used in Korea.

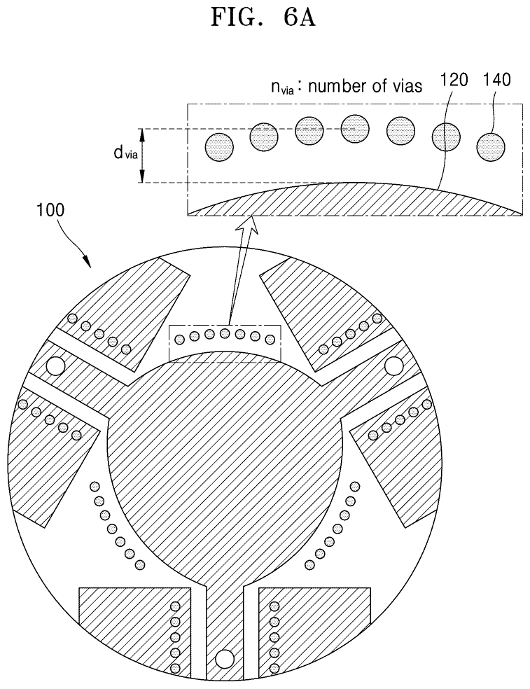

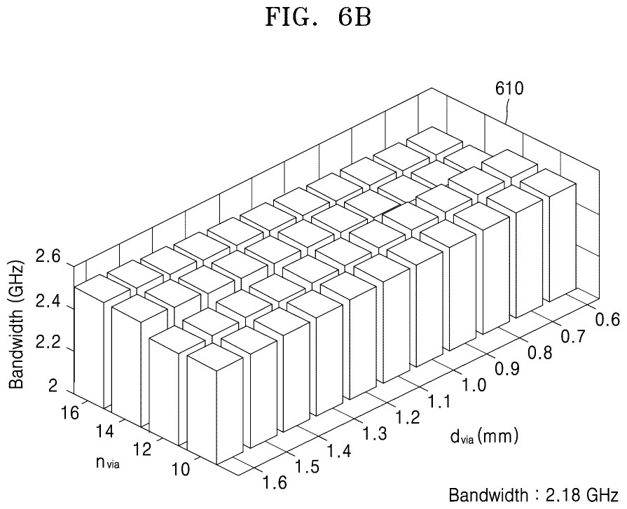

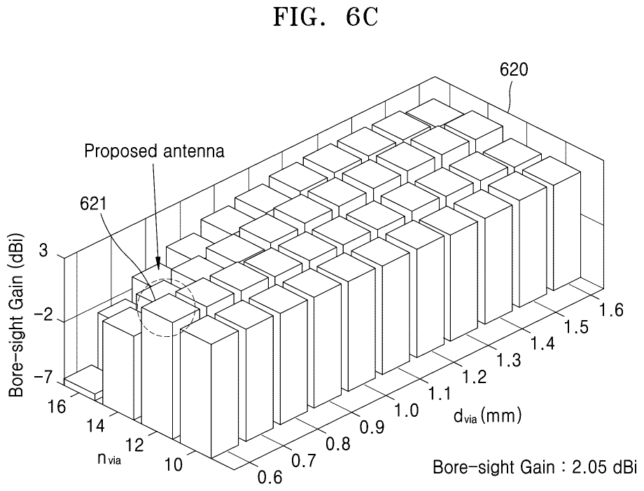

FIGS. 6A to 6C are graphs obtained by measuring the bandwidth and gain of an antenna according to an embodiment. FIG. 6A shows nᵥᵢₐ and dᵥᵢₐ on the antenna 100 illustrated in FIG. 2. The bandwidth and bore-sight gain are measured while changing the number nᵥᵢₐ of vias 140 located around the radiator 120 and the distance dᵥᵢₐ between the radiator 120 and the vias 140, and the results are shown in the first graph 610 of FIG. 6B and the second graph 620 of FIG. 6C.

As described above, in the antenna 100 according to an embodiment, the low gain characteristics due to a small radiation area are remedied by inserting the vias 140 around the radiator 120. Considering the bore-sight gain and reflection coefficient of the antenna 100, the number and location of the vias 140 are determined as follows.

nᵥᵢₐ=12

dᵥᵢₐ=0.6 mm

When the number and location of vias 140 are set as above, the result 621 of measuring the bore-sight gain of the antenna 100 is about 2.05 dBi as confirmed in the second graph 620 of FIG. 6C. In addition, it may be confirmed in the first graph 610 of FIG. 6B that the bandwidth of the antenna 100 is about 2.18 GHz.

### 4. Additional Structure (Slot) for Lowering Interference Characteristics

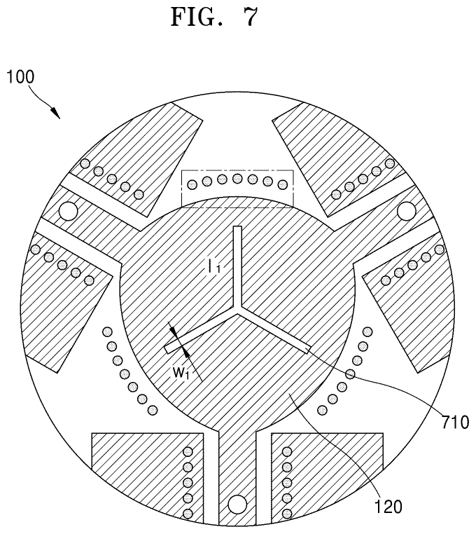

FIG. 7 is a diagram illustrating the structure of an antenna in which a slot is formed in a radiator, according to an embodiment. According to an embodiment, interference characteristics may be reduced by forming a slot 710 in the radiator 120 of the antenna 100.

Referring to FIG. 7, the slot 710 may be formed in a direction from the center of the radiator 120 toward the border of the radiator 120. In addition, the slot 710 may be formed to extend from the center of the radiator 120 toward the center point between two adjacent ports. In addition, the slot 710 may be formed in a rotationally symmetrical form. Depending on the length I₁ and width w₂ of the slot 710, the mutual interference characteristics between the ports may vary, and the length I₁ and width w₂ of the slot 710 may be determined to have optimal mutual interference characteristics through experiments.

By forming the slot 710 in the radiator 120, not only may the interference characteristics be reduced, but also the radiation pattern of the antenna 100 may be adjusted and the bandwidth thereof may be widened depending on the shape and location of the slot 710.

### 5. Direction Finding Using an SRMP Antenna According to Embodiments

FIG. 8 is a diagram illustrating a method of finding a direction by using an antenna, according to an embodiment. An antenna according to an embodiment has ports port 1, port 2, and port 3 arranged at 120-degree intervals, and thus, a monopulse ratio may be obtained in three different planes to find a direction.

As illustrated in FIG. 8, three estimation planes (zα-plane, zβ-plane, and zy-plane) for using a monopulse direction finding method may be defined. An example of defining the zα-plane is illustrated in the first region 810. The α-axis is parallel to the straight line connecting the first port (port 1) to the second port (port 2), and forms an angle of 30 degrees with the x-axis. An example of defining the zβ-plane is illustrated in the second region 820. The B-axis is parallel to the straight line connecting the first port (port 1) to the third port port 3, and forms an angle of −30 degrees with the x-axis. An example of defining the zy-plane is illustrated in the third region 830. The y-axis is parallel to the straight line connecting the second port (port 2) to the third port (port 3), and forms an angle of 90 degrees with the x-axis.

An equation for measuring the Direction of Arrival (DoA) for the zα-plane by using a signal received at the first port (port 1) and the second port (port 2) is as follows.

$${S}_{α} = {P}_{1} - {P}_{2} \text{?} \qquad [ Equation 1 ]$$

$${D}_{α} = \vert {P}_{1} - {P}_{2} \vert \qquad [ Equation 2 ]$$

$${r}_{m} = \frac{{D}_{α}}{{S}_{α}} \qquad [ Equation 3 ]$$

$$\text{?} \text{indicates text missing or illegible when filed}$$

P₁ and P₂ are signals input to the first port (port 1) and the second port (port 2), respectively. A sum signal may be obtained according to Equation 1, a difference signal may be obtained according to Equation 2, and then a direction (angle) in the zα-plane may be obtained according to Equation 3.

In the same way, the DoA may be measured for the zβ-plane by using a signal received at the first port (port 1) and the third port (port 3), and the DoA may be measured for the zy-plane by using a signal received at the second port (port 2) and the third port (port 3).

In this way, the direction of a terminal that transmits a signal may be accurately found using the DoA measured for the three estimation planes (zα-plane, zβ-plane, and zy-plane).

As described above, the antenna according to an embodiment has the advantage of enabling direction finding with one antenna by forming a plurality of ports (feed points) on one radiator, thereby enabling miniaturization of an antenna module. In addition, the antenna according to an embodiment may be expected to have the effect of preventing interference between ports by forming the ports (feed points) in a CPW structure. In addition, the antenna according to an embodiment may be expected to have the effect of increasing gain and reducing interference characteristics by arranging a plurality of vias around a radiator and on a CPW ground.

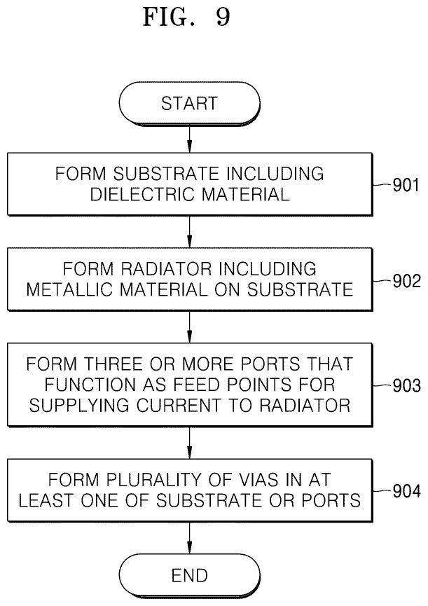

Hereinafter, a method of manufacturing an antenna according to an embodiment will be described. FIG. 9 is a flowchart illustrating a method of manufacturing an antenna according to an embodiment.

Referring to FIG. 9, in operation 901, an antenna manufacturing device may form a substrate including a dielectric material.

In operation 902, the antenna manufacturing device may form, on the substrate, a radiator including a metallic material. According to an embodiment, the curvature of the radiator formed by the antenna manufacturing device may be expressed as a quadratic function (e.g., f(x)=ax²+d₁) determined according to the shortest distance di among distances from the border of the radiator to the center of the radiator.

In operation 903, the antenna manufacturing device may form three or more ports functioning as feed points that supply current to the radiator. According to an embodiment, the antenna manufacturing device may form the ports in a CPW structure. In addition, according to an embodiment, operation 903 may include an operation in which the antenna manufacturing device forms a central strip for transmitting current, and an operation in which the antenna manufacturing device forms CPW grounds at a certain interval on both sides of the central strip. According to an embodiment, the ports may be connected to the border of the radiator. In addition, the ports may be formed at a certain interval from each other and in a rotationally symmetrical form.

In operation 904, the antenna manufacturing device may form a plurality of vias on at least one of the substrate or the ports. According to an embodiment, the plurality of vias may include at least one of a first via formed at a certain interval from the radiator and a second via formed on the ports.

According to an embodiment, the antenna manufacturing device may form a plurality of second vias on the CPW grounds to be arranged in a direction parallel to the central strip. In addition, according to an embodiment, the antenna manufacturing device may form a plurality of first vias along the border of the radiator to be arranged at a preset interval from the border of the radiator.

In addition, the antenna manufacturing device may form a slot in the radiator. The antenna manufacturing device may form the slot in a direction from the center of the radiator toward the border of the radiator. In addition, the antenna manufacturing device may form the slot to extend from the center of the radiator toward a center point between two adjacent ports among the ports. In addition, the antenna manufacturing device may form the slot in a rotationally symmetrical form.

An SRMP antenna according to an embodiment may include a substrate including a dielectric material, a radiator formed on the substrate, three or more ports functioning as feed points for supplying current to the radiator, and a plurality of vias formed on the substrate or at least one of the ports, wherein the plurality of vias may include at least one of a first via formed at a certain interval from the radiator and a second via formed on the ports.

According to an embodiment, the ports may be formed in a CPW structure and may include a central strip for transmitting current and CPW grounds located at a certain interval on both sides of the central strip.

According to an embodiment, the second via may be formed on the CPW grounds, and a plurality of second vias may be formed to be arranged in a direction parallel to the central strip.

According to an embodiment, a plurality of first vias may be formed along the border of the radiator to be arranged at a preset interval from the border of the radiator.

According to an embodiment, the curvature of the border of the radiator may be expressed as a quadratic function determined according to the shortest distance from the border of the radiator to the center of the radiator.

According to an embodiment, the SRMP antenna may further include a slot formed in the radiator, and the slot may be formed in a direction from the center of the radiator toward the border of the radiator, may be formed to extend from the center of the radiator toward a center point between two adjacent ports among the ports, and may be formed in a rotationally symmetrical form.

According to an embodiment, the ports may be connected to the border of the radiator and may be formed in a rotationally symmetrical form at a certain interval from each other.

A method of manufacturing an SRMP antenna according to an embodiment may include forming a substrate including a dielectric material, forming, on the substrate, a radiator including a metallic material, forming three or more ports that function as feed points for supplying current to the radiator, and forming a plurality of vias on the substrate or at least one of the ports, wherein the plurality of vias may include at least one of a first via formed at a certain interval from the radiator and a second via formed on the ports.

According to an embodiment, the ports may be formed in a CPW structure, and the forming of the ports may include forming a central strip for transmitting current and forming CPW grounds at a certain interval on both sides of the central strip.

According to an embodiment, the forming of the plurality of vias may include forming a plurality of second vias on the CPW grounds to be arranged in a direction parallel to the central strip.

According to an embodiment, the forming of the plurality of vias may include forming a plurality of first vias along the border of the radiator to be arranged at a preset interval from the border of the radiator.

According to an embodiment, in the forming of the radiator, the curvature of the border of the radiator may be expressed as a quadratic function determined according to the shortest distance from the border of the radiator to the center of the radiator.

According to an embodiment, the method may further include forming a slot in the radiator, wherein the slot may be formed in a direction from the center of the radiator toward the border of the radiator, may be formed to extend from the center of the radiator toward a center point between two adjacent ports among the ports, and may be formed in a rotationally symmetrical form.

According to an embodiment, the ports may be connected to the border of the radiator and may be formed in a rotationally symmetrical form at a certain interval from each other.

Various embodiments may be implemented or supported by one or more computer programs, and computer programs may be formed from computer-readable program code and may be recorded in a computer-readable medium. In the disclosure, the “application” and “program” are one or more computer programs, software components, command sets, procedures, functions, objects, classes, instances, related data, or parts thereof, which are suitable for implementation in computer readable program code. The “computer-readable program code” may include various types of computer codes including source code, purpose code, and executable code. The “computer-readable medium” may include various types of media to be accessed by a computer, such as read only memory (ROM), random access memory (RAM), hard disk drive (HDD), compact disc (CD), digital video disc (DVD), or various types of memories.

A device-readable storage medium may be provided in the form of a non-transitory storage medium. Here, the “non-transitory storage medium” is a tangible device and may exclude wired, wireless, optical, or other communication links that transmit temporary electrical or other signals. The “non-transitory storage medium” may not distinguish between semi-permanent and temporary storage of data in the storage medium. For example, “non-transitory storage medium” may include a buffer in which data is temporarily stored. A computer-readable medium may be any available medium to be accessed by a computer, and may include volatile and non-volatile media, and separate and non-separated media. The computer-readable medium includes a medium in which data is permanently stored and a medium in which data is stored and overwritten later, such as a rewritable optical disk or an erasable memory device.

According to an embodiment, the method according to the various embodiments disclosed herein may be included in a computer program product and provided. The computer program product may be traded between a seller and a buyer as a product. The computer program product may be distributed in the form of a storage medium (e.g. compact disk read only memory (CD-ROM)) that is to be read on a device, or may be distributed (e.g., downloaded or uploaded) directly or online through an application store or between two user devices (e.g., smartphones). In the case of online distribution, at least some of the computer program products (e.g., downloadable application) may be at least temporarily stored in a device-readable storage medium such as a server of a manufacturer, a server of an application server, or a memory of a relay server, or may be temporarily generated.

The above description of the disclosure is for an example, and one of ordinary skill in the art understands that various changes in form and details may be easily made without changing the technical ideas or required characteristics of the disclosure. For example, the technologies may be performed in a different order from the described methods, and/or the system, structure, device, and circuit described above may be coupled or combined in a different form from the methods described above, or may be replaced or substituted by elements or equivalent objects, thereby achieving appropriate results. Therefore, the above-described embodiments need to be understood as exemplary and not limited in any way. For example, each component described in a single type may be distributed and performed, and similarly, components that are described as distributed may also be performed in a combined form.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A single radiator multi-port antenna comprising:
a substrate comprising a dielectric material;
a radiator formed on the substrate;
three or more ports configured to function as feed points for supplying a current to the radiator; and
a plurality of vias formed in the substrate or at least one of the three or more ports,
wherein the plurality of vias comprise at least one of a first via formed at a certain interval from the radiator and a second via formed in the three or more ports.

2. The single radiator multi-port antenna of claim 1, wherein the three or more ports are formed in a Coplanar Waveguide (CPW) structure,
wherein each of the three or more ports comprises:
a central strip configured to transmit a current; and
CPW grounds located at a certain interval on both sides of the central strip.

3. The single radiator multi-port antenna of claim 2, wherein the second via is formed in the CPW grounds, and a plurality of second vias are formed in a direction parallel to the central strip.

4. The single radiator multi-port antenna of claim 1, wherein a plurality of first vias are formed along a border of the radiator at a preset interval from the border of the radiator.

5. The single radiator multi-port antenna of claim 1, wherein a curvature of a border of the radiator is expressed as a quadratic function determined according to a shortest distance from the border of the radiator to a center of the radiator.

6. The single radiator multi-port antenna of claim 1, further comprising a slot formed in the radiator,
wherein the slot is formed in a direction from a center of the radiator toward a border of the radiator, is formed to extend from the center of the radiator toward a center point between two adjacent ports among the ports, and is formed in a rotationally symmetrical form.

7. The single radiator multi-port antenna of claim 1, wherein the three or more ports are connected to a border of the radiator and are formed in a rotationally symmetrical form at a certain interval from each other.

8. A method of manufacturing a single radiator multi-port antenna, the method comprising:
forming a substrate comprising a dielectric material;
forming, on the substrate, a radiator comprising a metallic material;
forming three or more ports that function as feed points for supplying a current to the radiator; and
forming a plurality of vias in the substrate or at least one of the three or more ports,
wherein the plurality of vias comprise at least one of a first via formed at a certain interval from the radiator and a second via formed in the three or more ports.

9. The method of claim 8, wherein the three or more ports are formed in a Coplanar Waveguide (CPW) structure,
wherein the forming of the three or more ports comprises:
forming a central strip for transmitting a current; and
forming CPW grounds at a certain interval on both sides of the central strip.

10. The method of claim 9, wherein the forming of the plurality of vias comprises forming a plurality of second vias in the CPW grounds in a direction parallel to the central strip.

11. The method of claim 8, wherein the forming of the plurality of vias comprises forming a plurality of first vias along a border of the radiator at a preset interval from the border of the radiator.

12. The method of claim 8, wherein, in the forming of the radiator, a curvature of a border of the radiator is expressed as a quadratic function determined according to a shortest distance from the border of the radiator to a center of the radiator.

13. The method of claim 8, further comprising forming a slot in the radiator, wherein the slot is formed in a direction from a center of the radiator toward a border of the radiator, is formed to extend from the center of the radiator toward a center point between two adjacent ports among the ports, and is formed in a rotationally symmetrical form.

14. The method of claim 8, wherein the three or more ports are connected to a border of the radiator and are formed in a rotationally symmetrical form at a certain interval from each other.
